(19) United States
(12) Patent Application Publication
(10) Pub. No.: US 2014/0087193 A1
(43) Pub. Date: Mar. 27, 2014

(54) METHODS FOR PRODUCING ION EXCHANGED GLASS AND RESULTING APPARATUS

(71) Applicants: Jeffrey Scott Cites, Horseheads, NY (US); Thomas Michael Cleary, Elmira, NY (US); James Gregory Couillard, Ithaca, NY (US); Michael John Moore, Corning, NY (US)

(72) Inventors: Jeffrey Scott Cites, Horseheads, NY (US); Thomas Michael Cleary, Elmira, NY (US); James Gregory Couillard, Ithaca, NY (US); Michael John Moore, Corning, NY (US)

(21) Appl. No.: 13/626,958

(22) Filed: Sep. 26, 2012

(51) Int. Cl. C03C 21/00; B32B 17/00

(52) U.S. Cl. 428/410; 65/30.14

(57) ABSTRACT

Methods and apparatus provide for performing an ion exchange process by immersing a glass sheet into a molten salt bath at one or more first temperatures for a first period of time such that ions within the glass sheet proximate to a surface thereof are exchanged for larger ions from the molten salt bath, thereby producing: (i) an initial compressive stress (iCS) at the surface of the glass sheet, (ii) an initial depth of compressive layer (iDOL) into the glass sheet, and (iii) an initial central tension (iCT) within the glass sheet; and annealing the glass sheet, after the ion exchange process has been completed, by elevating the glass sheet to one or more second temperatures for a second period of time such that at least one of the initial compressive stress (iCS), the initial depth of compressive layer (iDOL), and the initial central tension (iCT) are modified.

### BACKGROUND

1. Field of the Disclosure

The embodiments disclosed herein relate to methods for producing ion exchanged glass, especially such glass with characteristics of moderate compressive stress, high depth of compressive layer, and/or desirable central tension.

2. Related Discussion

Glass laminates can be used as windows and glazing in architectural and vehicle or transportation applications, including automobiles, rolling stock, locomotive and airplanes. Glass laminates can also be used as glass panels in balustrades and stairs, and as decorative panels or coverings for walls, columns, elevator cabs, kitchen appliances and other applications. As used herein, a glazing or a laminated glass structure is a transparent, semi-transparent, translucent or opaque part of a window, panel, wall, enclosure, sign or other structure. Common types of glazing that are used in architectural and/or vehicle applications include clear and tinted laminated glass structures.

Conventional automotive glazing constructions may consist of two plies of 2 mm soda lime glass with a polyvinyl butyral (PVB) interlayer. These laminate constructions have certain advantages, including, low cost, and a sufficient impact resistance for automotive and other applications. However, because of their limited impact resistance, these laminates usually exhibit poor performance characteristics, including a higher probability of breakage when struck by roadside debris, vandals and other objects of impact.

In applications where strength is important (such as the above automotive application), the strength of conventional glass may be enhanced by several methods, including coatings, thermal tempering, and chemical strengthening (ion exchange). Thermal tempering is commonly used with thick, monolithic glass sheets, and has the advantage of creating a thick compressive layer through the glass surface, typically 20 to 25% of the overall glass thickness. Disadvantageously, however, the magnitude of the compressive stress is relatively low, typically less than 100 MPa. Furthermore, thermal tempering becomes increasingly ineffective for relatively thin glass, such as less than about 2 mm.

In contrast, ion exchange (IX) techniques can produce high levels of compressive stress in the treated glass, as high as about 1000 MPa at the surface, and is suitable for very thin glass. Disadvantageously, however, ion exchange is limited to relatively shallow compressive layers, typically on the order of tens of micrometers or so. The high compressive stress may result in very high blunt impact resistance, which might not pass particular safety standards for automotive applications, such as the ECE (UN Economic Commission for Europe) R43 Head Form Impact Test, where the glass is required to break at a certain impact load to prevent injury.

Although the conventional single step ion exchange processes may employ a long ion exchange step to achieve a higher depth of compressive layer (DOL), such lengthy durations also result in a rise in the central tension (CT) past a chosen frangibility limit of the glass, resulting in undesirable fragmentation of the glass. By way of example, it has been newly discovered by experimentation that a 4 inch×4 inch×0.7 mm sheet of Corning® Gorilla Glass® will, upon fracture, exhibit undesirable fragmentation (energetic failure into a large number of small pieces) when a long single step ion exchange process (8 hours at 475° C.) has been performed in pure KNO₃. Indeed, although a DOL of about 101 μm was achieved, a relatively high CT of 65 MPa results, which was higher than the desired frangibility limit (48 MPa) of the subject glass sheet.

Further, it has been newly discovered that installed automotive glazing (using ion exchanged glass) may develop external scratches as deep as about 75 μm due to exposure to environmental abrasive materials such as silica sand, flying debris, etc. This depth will exceed the typical depth of compressive layer (e.g., a few tens of micrometers), which could lead to the glass unexpectedly fracturing.

In view of the foregoing, new methods and apparatus are needed to address certain glass applications, where moderate compressive stress, high depth of compressive layer, and/or desirable central tension are important considerations.

### SUMMARY

In accordance with one or more embodiments herein, methods and apparatus provide for a thin glass article with a layer of surface compression from ion exchange techniques, which enables scratch and impact resistance. The glass article exhibits a relatively high depth of compressive layer (DOL), making it resistant to environmental damage. Notably, the compressive stress (CS) at the glass surface is lower than in traditional ion exchanged glass, which allows the glass to pass automotive impact safety standards (such as the ECE R43 head form impact test) and is therefore suitable for automotive glazing applications.

By way of example, one or more embodiments may involve an ion exchange process for obtaining thin glass with moderate CS and high DOL, including: (i) an ion exchange step, and (ii) an anneal step.

In accordance with one or more embodiments, methods and apparatus provide for and/or result in a product by performing one or more actions, including: performing an ion exchange process by immersing a glass sheet into a molten salt bath at one or more first temperatures for a first period of time such that ions within the glass sheet proximate to a surface thereof are exchanged for larger ions from the molten salt bath, thereby producing: (i) an initial compressive stress (iCS) at the surface of the glass sheet, (ii) an initial depth of compressive layer (iDOL) into the glass sheet, and (iii) an initial central tension (iCT) within the glass sheet. The actions may further include annealing the glass sheet, after the ion exchange process has been completed, by elevating the glass sheet to one or more second temperatures for a second period of time such that at least one of the initial compressive stress (iCS), the initial depth of compressive layer (iDOL), and the initial central tension (iCT) are modified.

The actions may further provide that during the ion exchange process, at least one of: (i) the molten salt bath includes KNO₃, (ii) the one or more first temperatures are within the range of about 370-500° C., and (iii) the first time period is within the range of about 4-24 hours, such as about 8 hours.

The actions may further provide that during the annealing process, at least one of: (i) the anneal process is carried out in an air environment; (ii) the one or more second temperatures are within the range of about 400-550° C., and (iii) the second time period is within the range of about 0.5-24 hours, such as about 8 hours.

The actions may further provide that after the ion exchange process, the initial compressive stress (iCS) exceeds a predetermined value, and after the annealing process the initial compressive stress (iCS) is reduced to a final compressive stress (fCS) which is at or below the predetermined value.

The actions may further provide that after the ion exchange process, the initial depth of compressive layer (iDOL) is below a predetermined value, and after the annealing process the initial depth of compressive layer (IDOL) is increased to a final depth of compressive layer (fDOL) which is at or above the predetermined value.

The actions may further provide that after the ion exchange process, the initial central tension (iCT) exceeds a predetermined value, and after the annealing process the initial central tension (iCT) is reduced to a final central tension (fCT) which is at or below the predetermined value.

The actions may further provide that the initial compressive stress (iCS) is at or greater than about 500 MPa, and the final compressive stress (fCS) is at or less than about 400 MPa, such as less than about 350 MPa, or less than about 300 MPa.

The actions may further provide that the initial depth of compressive layer (iDOL) at or less than about 75 μm, with about 40 μm being typical, and the final depth of compressive layer (fDOL) is at or above about 90 μm, or at or above about 80 μm.

The actions may further provide that the initial central tension (iCT) is at or above a chosen desired frangibility limit of the glass sheet, and the final central tension (fCT) is below the chosen frangibility limit of the glass sheet.

By way of example, an apparatus produced using one or more embodiments herein may include a glass sheet having: (i) a compressive stress (CS) at a surface of the glass sheet, having been subject to ion exchange, that is at or less than about 400 MPa, or less than about 350 MPa, or less than about 300 MPa, (ii) a depth of compressive layer (DOL) into the glass sheet that is at or above about 80 μm, or at or above about 90 μm, and (iii) a central tension (CT) within the glass sheet that is below a chosen frangibility limit of the glass sheet.

Other aspects, features, and advantages of the embodiments disclosed and discussed herein will be apparent to one skilled in the art from the description herein taken in conjunction with the accompanying drawings.

### DESCRIPTION OF THE DRAWINGS

For the purposes of illustration, there are forms shown in the drawings that are presently preferred, it being understood, however, that the embodiments disclosed and discussed herein are not limited to the precise arrangements and instrumentalities shown.

FIG. 1 is a flow diagram illustrating one or more process steps that may be carried out in accordance with one or more embodiments disclosed herein;

FIG. 2 is a graph illustrating changes in one or more characteristics of a glass sheet that has been subject to one or more of the process steps of FIG. 1;

FIG. 3 is a graph illustrating changes in the compressive stress of a surface of the glass sheet that has been subject to one or more of the process steps of FIG. 1; and

FIG. 4 is a graph illustrating changes in the fracturing load for numerous glass sheets that have been subject to one or more of the process steps of FIG. 1 as compared with glass sheets that have not been processed.

### DETAILED DESCRIPTION OF THE PREFERRED EMBODIMENTS

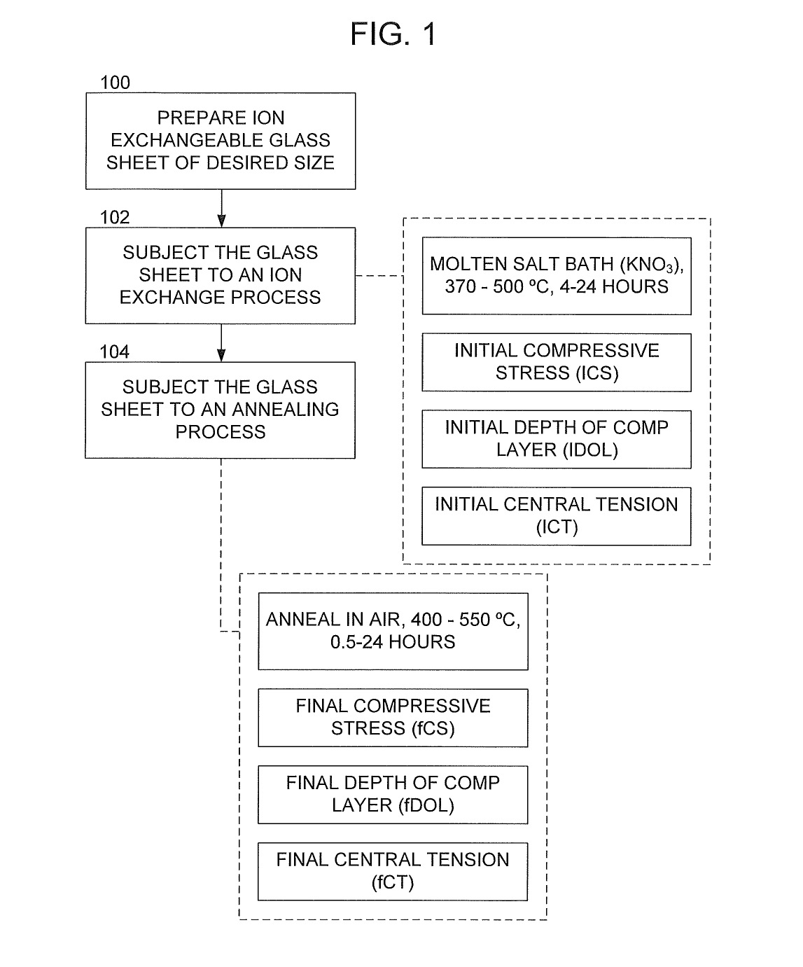

With reference to the drawings wherein like numerals indicate like elements there is shown in FIG. 1 a flow diagram illustrating one or more process steps that may be carried out in accordance with one or more embodiments disclosed herein.

The embodiments herein involve the application of one or more novel processes for producing a relatively thin glass sheet (on the order of about 2 mm or less) having certain characteristics, such as relatively moderate compressive stress (CS), relatively high depth of compressive layer (DOL), and/or moderate central tension (CT). The process begins with preparing a glass sheet that is capable of ion exchange (step 100). Details concerning the properties of the glass sheet as concerns ion exchange will be discussed later herein. Next, the glass sheet is subject to an ion exchange process (step 102), and thereafter the glass sheet is subject to an anneal process (step 104).

The ion exchange process 102 may involve at least one of: (i) subjecting the glass sheet to a molten salt bath including KNO₃, preferably relatively pure KNO₃, (ii) one or more first temperatures within the range of about 400-500° C., and (iii) a first time period within the range of about 4-24 hours, such as about 8 hours. It is noted that other salt bath compositions are possible and would be within the skill level of an artisan to consider such alternatives. The ion exchange process will produce: (i) an initial compressive stress (iCS) at the surface of the glass sheet, (ii) an initial depth of compressive layer (iDOL) into the glass sheet, and (iii) an initial central tension (iCT) within the glass sheet.

In general, after the ion exchange process, the initial compressive stress (iCS) will likely exceed a predetermined (or desired) value, such as being at or greater than about 500 MPa, and will typically reach 600 MPa or higher, and may even reach 1000 MPa or higher in some glasses and under some processing profiles. Alternatively and/or additionally, after the ion exchange process, the initial depth of compressive layer (iDOL) will likely be below a predetermined (or desired) value, such as being at or less than about 75 μm or even lower in some glasses and under some processing profiles. Alternatively and/or additionally, after the ion exchange process, the initial central tension (iCT) will likely exceed a predetermined (or desired) value, such as exceeding a chosen frangibility limit of the glass sheet, which may be at or exceeding about 40 MPa, or more particularly at or exceeding about 48 MPa in some glasses.

The fact that the initial compressive stress (iCS) may exceed a desired value, the initial depth of compressive layer (IDOL) may be below a desired value, and/or the initial central tension (iCT) may exceed a desired value, may lead to some undesirable characteristics in a final product made using the glass sheet. For example, if the initial compressive stress (iCS) exceeds a desired value (reaching for example, 1000 MPa), then facture of the glass under certain circumstances might not occur. Although such may be counter-intuitive, in some circumstances one may wish for the glass sheet to break, such as in an automotive glass application where the glass must break at a certain impact load to prevent injury.

Further, if the initial depth of compressive layer (iDOL) is below a desired value, then under certain circumstances the glass sheet may break unexpectedly and under undesirable circumstances. Indeed, typical ion exchange processes result in the initial depth of compressive layer (iDOL) being no more than about 70-75 μm, which may be less than the depth of scratches, pits, dings, etc., that may develop in the glass sheet during use. For example, it has been discovered by our experimentation that installed automotive glazing (using ion exchanged glass) may develop external scratches reaching as deep as about 75 μm or more due to exposure to abrasive materials such as silica sand, flying debris, etc., within the environment in which the glass sheet may be used. This depth may very well exceed the typical depth of compressive layer, which could lead to the glass unexpectedly fracturing during use into a high piece count.

Finally, if the initial central tension (iCT) exceeds a desired value, such as reaching or exceeding a chosen frangibility limit of the glass, then the glass sheet may break unexpectedly and under undesirable circumstances. For example, we have discovered through experimentation that a 4 inch×4 inch×0.7 mm sheet of Corning® Gorilla Glass® exhibits performance characteristics in which undesirable fragmentation (energetic failure into a large number of small pieces when broken) occurs when a long single step ion exchange process (8 hours at 475° C.) has been performed in pure KNO₃. Although a DOL of about 101 μm was achieved, a relatively high CT of 65 MPa resulted, which was higher than the chosen frangibility limit (48 MPa) of the subject glass sheet.

In accordance with one or more embodiments, however, after the glass sheet has been subject to ion exchange, the glass sheet is subject to the annealing process 104 by elevating the glass sheet to one or more second temperatures for a second period of time. For example, the annealing process 104 may include at least one of: (i) that the process is carried out in an air environment; (ii) that the one or more second temperatures are within the range of about 400-500° C., and (iii) that the second time period is within the range of about 4-24 hours, such as about 8 hours. The annealing process 104 causes at least one of the initial compressive stress (iCS), the initial depth of compressive layer (iDOL), and the initial central tension (iCT) to be modified.

For example, after the annealing process 104, the initial compressive stress (iCS) is reduced to a final compressive stress (fCS) which is at or below the predetermined value. By way of example, the initial compressive stress (iCS) may be at or greater than about 500 MPa, but the final compressive stress (fCS) may be at or less than about 400 MPa, 350 MPa, or 300 MPa. It is noted that the target for the final compressive stress (fCS) will be a function of glass thickness because in thicker glass a lower fCS will often be desirable, and in thinner glass a higher fCS may be tolerable.

Additionally and/or alternatively, after the annealing process 104, the initial depth of compressive layer (iDOL) is increased to a final depth of compressive layer (fDOL) which is at or above the predetermined value. By way of example, the initial depth of compressive layer (iDOL) may be at or less than about 75 μm, and the final depth of compressive layer (f DOL) may be at or above about 80 μm or 90 μm, such as 100 μm or more.

Additionally and/or alternatively, after the annealing process 104, the initial central tension (iCT) may be reduced to a final central tension (fCT) which is at or below the predetermined value. By way of example, the initial central tension (iCT) may be at or above a chosen frangibility limit of the glass sheet (such as between about 40-48 MPa), and the final central tension (fCT) is below the chosen frangibility limit of the glass sheet.

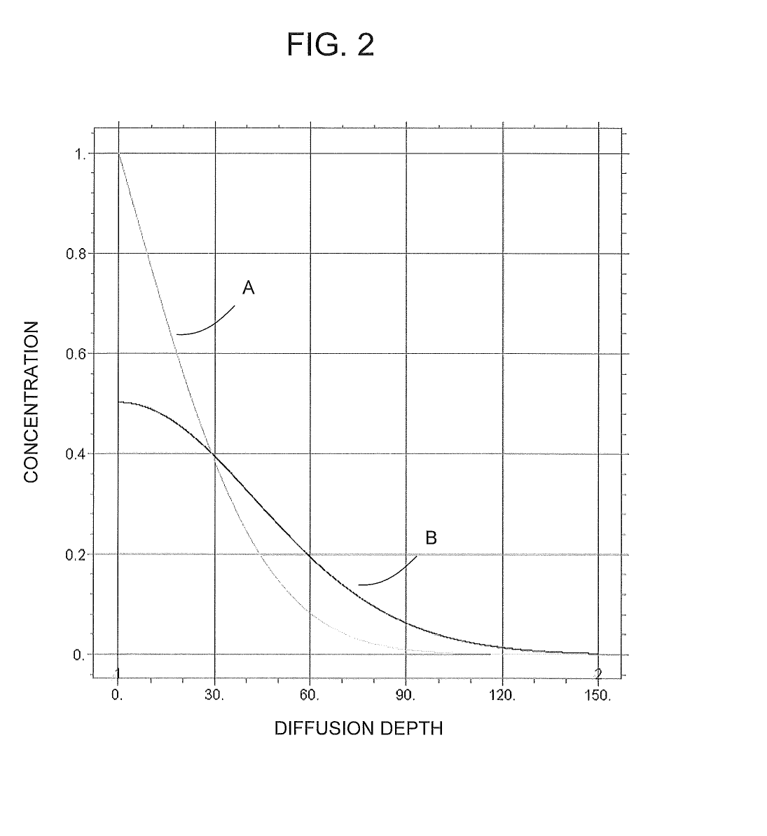

To illustrate the above characteristics of the glass sheet as between pre- and post-anneal conditions, reference is made to FIG. 2, which is a graph illustrating changes in a potassium profile in a glass sheet. The glass sheet was a 4 inch×4 inch×0.7 mm sheet of Corning® Gorilla Glass®, which was subject to ion exchange in a molten salt bath of KNO₃ at 460° C. for 6 hours, followed by an anneal in air at 455° C. for 6 hours. The plot labeled A illustrates a simulation of the potassium profile in the glass sheet after ion exchange, but before the anneal process. The plot labeled B illustrates a simulation of the potassium profile in the glass sheet after the anneal process. The potassium profiles are illustrated as concentrations (normalized units) versus the diffusion depth in μm. Notably, there is a marked reduction in surface concentration (with corresponding reduction in compressive stress) and increase in diffusion depth after the anneal process.

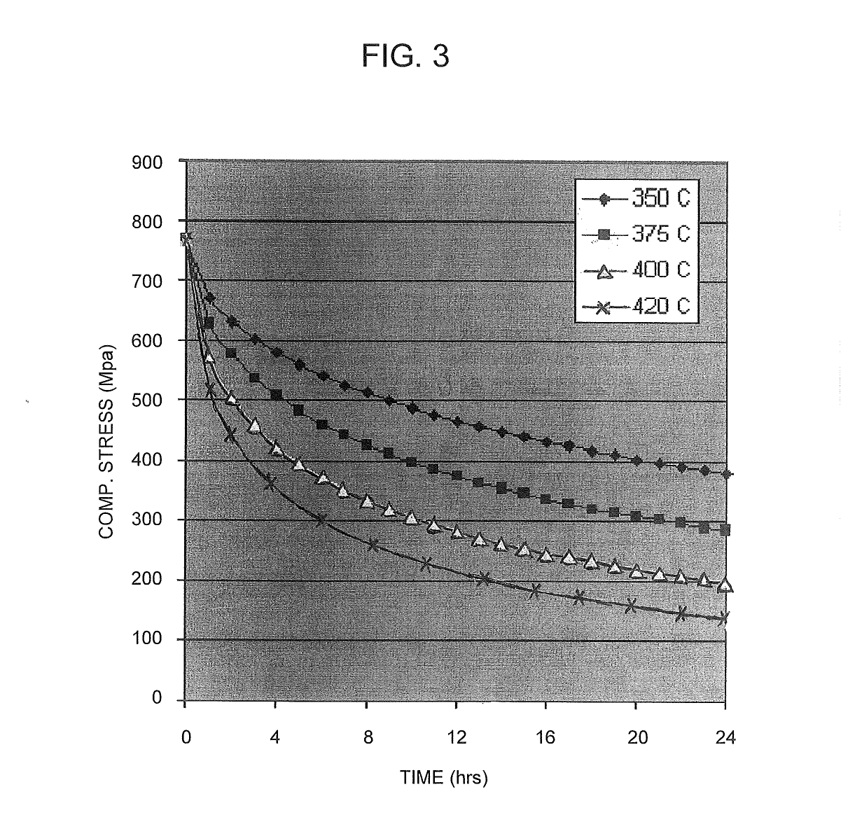

To further illustrate the changes in the characteristics of the glass sheet as between pre- and post-anneal conditions, reference is made to FIG. 3, which is a graph illustrating changes in the compressive stress (CS) of the surfaces of a number of glass sheets subject to differing anneal conditions. The glass sheets were each 4 inch×4 inch×0.7 mm in dimension formed from Corning® Gorilla Glass®. Each sheet was subject to ion exchange in a molten salt bath of KNO₃ at 460° C. for 6 hours, followed by annealing in air at varying temperatures for 6 hours. The various anneal temperatures were 350° C., 375° C., 400° C., and 420° C. Each glass sheet started with an initial compressive stress (iCS) of about 760 MPa just after the ion exchange process. During the annealing process, however, each glass sheet exhibited a lowering of the compressive stress as a function of time and temperature, yielding a final compressive stress (fCS) significantly below the iCS.

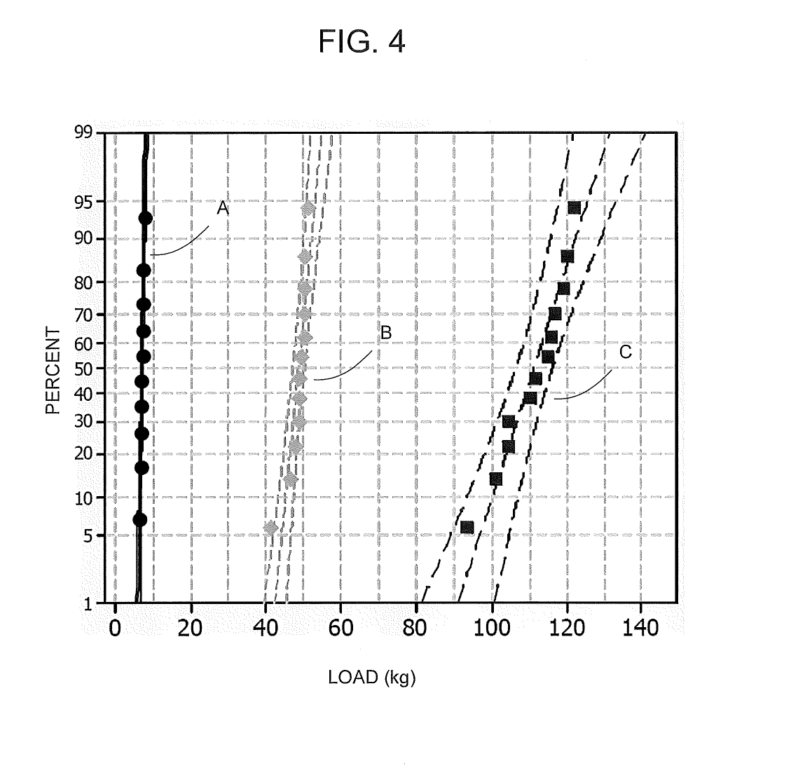

To still further illustrate the changes in the characteristics of the glass sheet as between pre- and post-anneal conditions, reference is made to FIG. 4, which is a graph illustrating changes in the fracturing load for numerous glass sheets that have been subject to ion exchange followed by annealing. The glass sheets were each 4 inch×4 inch×0.7 mm in dimension formed from Corning® Gorilla Glass®. Each sheet was subject to ion exchange in a molten salt bath of KNO₃ at 465° C. for 8 hours, followed by annealing in air at 460° C. for 5.5 hours. The glass sheets were subject to an abraded ring-on-ring failure load. A baseline is illustrated by the plot labeled A illustrating the breakage characteristics of ten as-drawn glass sheets. The plot A shows a mean fracture load of 7.144 kg, a standard deviation of 0.4355, an AD-value of 0.335, and a P-value of 0.430. After ion exchange but without annealing, twelve glass sheets were tested and, as illustrated in the plot labeled C, found to exhibit a mean fracture load of 111.3 kg, a standard deviation of 8.713, an AD-value of 0.321, and P-value of 0.482. After ion exchange and annealing, twelve glass sheets were tested and, as illustrated in the plot labeled B, found to exhibit a mean fracture load of 48.72 kg, a standard deviation of 2.681, an AD-value of 1.085, and P-value of less than 0.005.

In accordance with a general approach to establishing the parameters of the ion exchange and annealing processes, the conditions of each process step are adjusted based on the desired compressive stress (CS) at the glass surface, the desired depth of compressive layer (DOL), and the desired central tension (CT). In the ion exchange step, the time and temperature are chosen based on known experimental response models to reach a certain DOL. Thereafter, the time and temperature of the annealing step are chosen to achieve the desired final values of the compressive stress (CS), the depth of compressive layer (DOL), and the central tension (CT). Since air anneal processes are, in general, less costly than ion exchange processes, due to simpler capital equipment and reduced consumable costs, the respective time and temperature parameters of the ion exchange versus anneal can be balanced to optimize throughput and cost.

### Example 1

In a first example, a 4 inch×4 inch×0.7 mm glass sheet of Corning@ Gorilla Glass® (Code 2318) was subject to ion exchange in a molten salt bath of 100% KNO₃ at 460° C. for 6 hours, followed by annealing in air at 455° C. for 6 hours.

After ion exchange but before annealing, the glass sheet exhibited an initial compressive stress (iCS) of about 620 MPa and an initial depth of compressive layer (iDOL) of about 71.5 μm. The iDOL was lower than would be desired in a final article, however, in accordance with the embodiments discussed herein it was known that the DOL would increase during the anneal process. The temperature of the ion exchange process was chosen to reach a target for the iDOL in a reasonable time for manufacturing throughput, while staying below 480° C. to limit breakdown of the chemical bath. It is noted that depth of compressive layer (DOL) may be measured from the glass index, such as using a FSM-6000 or equivalent. The so-called “true DOL” for physical performance, defined as the depth at which the internal stress changes from compression to tension, will likely be shallower for most if not all glasses.

After ion exchange but before annealing, the glass sheet exhibited an initial compressive stress (iCS) that was lower than desired in the final product, and which was lower than would be achieved in glass sheets ion exchanged to shallower iDOLs. However, the iCS was still significant, i.e., about 620 MPa in the example. As noted above, the temperature of the ion exchange process was chosen to reach a target for the IDOL, but such choice also affected the iCS, and therefore it is noted that such choice may be a consideration in setting process parameters.

After ion exchange but before annealing, the glass sheet exhibited a relatively high initial central tension (iCT), which was higher than desired in the final article, however it was understood that the CT would decrease during the anneal process. The iCT was about 56 MPa in the example. With such a high CT (exceeding the chosen frangibility limit of the glass), if a flaw penetrated the DOL the glass would fracture due to the stored energy from the CT. It has been shown that above a certain minimum CT the piece count in broken glass is proportional to CT⁴, so a high CT may be undesirable. The critical CT for high piece count fragmentation varies with glass thickness. In a 0.7 mm thick glass sheet of Code 2318 glass, it has been found experimentally that a CT of less than 48 MPa will not break into multiple pieces from a single sharp flaw. As noted above, the temperature of the ion exchange process was chosen to reach a target for the iDOL, but such choice also affects the iCT, and therefore it is noted that such choice may be a consideration in setting process parameters.

Notably, the central tension (CT) is the dominant factor in determining breakage behavior. The CT is frequently approximated as CT=(CS*DOL)/(L−2*DOL), where L is the glass thickness. This approximation becomes increasingly inaccurate as the DOL increases and the concentration profile evolves during the anneal process. A more accurate measure of the central tension (CT) is the internal stress required such that the total stress within the part integrates to zero.

As noted above, the post ion exchange annealing process serves to increase the IDOL, while lowering the iCS and iCT. After the anneal of 6 hours at 455° C., the final compression stress (fCS) was about 227 MPa, the final depth of compressive layer (fDOL) was about 100 μm, and the final central tension (CT) was 42 MPa. The time of the annealing process was made equal to the ion exchange period to balance the manufacturing throughput conditions. The temperature was chosen to achieve a final depth of compressive layer (fDOL) of about 100 μm, and a final central tension (fCT) of less than about 48 MPa. The particular temperature may be estimated through simulation or trial and error. The final compressive stress (fCS) remained higher than that of bare or thermally tempered glass, and the resulting fDOL was greater than the depth of flaws typically found in some applications, such as auto glazing. Thus, if a flaw penetrates the fDOL, the low fCT should prevent undesirable fragmentation of the glass, which could obscure vision or release glass chips. The reduction in fCS lowers the load at which the glass will break to a desired level.

### Example 2

In a second example, a number of 1100×500 mm×0.7 mm glass sheets of Corning® Gorilla Glass® (Code 2318) were subject to ion exchange in a molten salt bath of 100% KNO₃ at 420° C. for 9.5 hours. This resulted in an initial compressive stress (iCS) of about 630 MPa and an initial depth of compressive layer (iDOL) of about 57 μm in each glass sheet. Two of the glass sheets were not annealed, and were laminated together using PVB. Ten of the glass sheets were annealed in air at 420° C. for 10 hours, and pairs of the ten sheets were laminated together using PVB. The anneal resulted in a final compressive stress (fCS) of about 290 MPa and a final depth of compressive layer (fDOL) of about 92 μm in each glass sheet.

The respective laminated structures were subject to automotive impact safety standard testing, i.e., ECE (UN Economic Commission for Europe) R43 headform impact testing. The test includes dropping a 10 Kg wooden headform from a height of 1.5 meters onto each laminated structure. In order to pass the test, the laminated structure must yield and break displaying numerous circular cracks centered approximately on the point of impact. Due to the high strength (the high iCS) of the laminated structure in which the annealing process was not performed, the structure failed to break within limits during the test. Each of the five laminated structures subject to the annealing process, however, fractured within specified limits and passed the regulatory test.

The processes described herein permit the formation of a thin glass article with a layer of surface compression, enabling higher retained strength and impact resistance over non-strengthened glass. The final compressive stress at the glass surface (fCS) is lower than in traditional ion exchange, which allows the glass to pass maximum strength and frangibility limits in applications where this is desirable. However the glass also retains a high final depth of compressive layer (fDOL), making it resistant to environmental damage.

The processes described herein may be suitable for a range of applications. One application of particular interest is for automotive glazing applications, whereby the process enables production of glass which can pass automotive impact safety standards. Other applications may be identified by those knowledgeable in the art.

### Further Details Regarding Ion Exchange—Glass Compositions

As noted above the conditions of the ion exchange step and the annealing step are adjusted to achieve the desired compressive stress at the glass surface (CS), depth of compressive layer (DOL), and central tension (CT). While all such characteristics are important, the ion exchange step is particularly directed to the depth of compressive layer (DOL).

The ion exchange step is carried out by immersion of the glass sheet into a molten salt bath for a predetermined period of time, where ions within the glass sheet at or near the surface thereof are exchanged for larger metal ions, for example, from the salt bath. By way of example, the molten salt bath may include KNO₃, the temperature of the molten salt bath may within the range of about 400-500° C., and the predetermined time period may be within the range of about 4-24 hours, and preferably between about 4-10 hours. The incorporation of the larger ions into the glass strengthens the sheet by creating a compressive stress in a near surface region. A corresponding tensile stress is induced within a central region of the glass sheet to balance the compressive stress.

By way of further example, sodium ions within the glass sheet may be replaced by potassium ions from the molten salt bath, though other alkali metal ions having a larger atomic radius, such as rubidium or cesium, may replace smaller alkali metal ions in the glass. According to particular embodiments, smaller alkali metal ions in the glass sheet may be replaced by Ag+ ions. Similarly, other alkali metal salts such as, but not limited to, sulfates, halides, and the like may be used in the ion exchange process.

The replacement of smaller ions by larger ions at a temperature below that at which the glass network can relax produces a distribution of ions across the surface of the glass sheet that results in a stress profile. The larger volume of the incoming ion produces a compressive stress (CS) on the surface and tension (central tension, or CT) in the center region of the glass. The compressive stress is related to the central tension by the following relationship:

$$CS = CT ( \frac{t - 2 DOL}{DOL} )$$

where t is the total thickness of the glass sheet and DOL is the depth of exchange, also referred to as depth of compressive layer.

Any number of specific glass compositions may be employed in producing the glass sheet. For example, ion-exchangeable glasses that are suitable for use in the embodiments herein include alkali aluminosilicate glasses or alkali aluminoborosilicate glasses, though other glass compositions are contemplated. As used herein, “ion exchangeable” means that a glass is capable of exchanging cations located at or near the surface of the glass with cations of the same valence that are either larger or smaller in size.

For example, a suitable glass composition comprises SiO₂, B₂O₃ and Na₂O, where (SiO₂+B₂O₃)≧66 mol. %, and Na₂O≧9 mol. %. In an embodiment, the glass sheets include at least 6 wt. % aluminum oxide. In a further embodiment, a glass sheet includes one or more alkaline earth oxides, such that a content of alkaline earth oxides is at least 5 wt. %. Suitable glass compositions, in some embodiments, further comprise at least one of K₂O, MgO, and CaO. In a particular embodiment, the glass can comprise 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

A further example glass composition suitable for forming hybrid glass laminates comprises: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. %≦(Li₂O+Na₂O+K₂O)≦20 mol. % and 0 mol. %≦(MgO+CaO)≦10 mol. %.

A still further example glass composition comprises: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≦(Li₂O+Na₂O+K2O)≦18 mol. % and 2 mol. %≦(MgO+CaO)≦7 mol. %.

In another embodiment, an alkali aluminosilicate glass comprises, consists essentially of, or consists of: 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

In a particular embodiment, an alkali aluminosilicate glass comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio

$$\frac{{Al}_{2} {O}_{3} + {B}_{2} {O}_{3}}{\sum modifiers} > 1 ,$$

where in the ratio the components are expressed in mol. % and the modifiers are alkali metal oxides. This glass, in particular embodiments, comprises, consists essentially of, or consists of: 58-72 mol. % SiO₂; 9-17 mol. % Al₂O₃; 2-12 mol. % B₂O₃; 8-16 mol. % Na₂O; and 0-4 mol. % K₂O, wherein the ratio

$$\frac{{Al}_{2} {O}_{3} + {B}_{2} {O}_{3}}{\sum modifiers} > 1.$$

In yet another embodiment, an alkali aluminosilicate glass substrate comprises, consists essentially of, or consists of: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; wherein 12 mol. %≦Li₂O+Na₂O+K₂O≦20 mol. % and 0 mol. %≦MgO+CaO≦10 mol. %.

In still another embodiment, an alkali aluminosilicate glass comprises, consists essentially of, or consists of: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. %≦SiO₂+B₂O₃+CaO≦69 mol. %; Na₂O+K₂O+B₂O₃+MgO+CaO+SrO>10 mol. %; 5 mol. %≦MgO+CaO+SrO≦8 mol. %; (Na₂O+B₂O₃)≦Al₂O₃≦2 mol. %; 2 mol. %≦Na₂O≦Al₂O₃≦6 mol. %; and 4 mol. %≦(Na₂O+K₂O)≦Al₂O₃≦10 mol. %.

### Advantages

One or more advantages of the above-discussed embodiments may include one or more of the following:

an improved, retained strength and impact resistance as compared with non-strengthened glass;

relatively higher compressive stress and higher compatibility with thin glass as compared with conventional thermal tempering of glass;

relatively higher depth of compressive layer as compared with standard, single step, ion exchange techniques; and

considerably lower costs to achieve a relatively high DOL as compared with conventional, single step ion exchange processes, due to reduced cycle time and less costly capital equipment requirements. For example, in the novel ion exchange process in a mixed alkali bath (e.g., 50% KNO₃+50% NaNO₃), lower processing costs are achieved. Notably, although sodium-containing baths can be employed to achieve lower CS, the corresponding reduction in diffusion speed significantly increases the time to reach relatively high DOL.

Although the embodiments disclosed and discussed herein have been described with reference to particular aspects, features, characteristics, etc., it is to be understood that these embodiments are merely illustrative of certain principles and applications. It is therefore to be understood that numerous modifications may be made to the illustrative embodiments and that other arrangements may be devised without departing from the spirit and scope of the disclosure and/or the properties as defined by the appended claims.

1. A method, comprising:
performing an ion exchange process by immersing a glass sheet into a molten salt bath at one or more first temperatures for a first period of time such that ions within the glass sheet proximate to a surface thereof are exchanged for larger ions from the molten salt bath, thereby producing: (i) an initial compressive stress (iCS) at the surface of the glass sheet, (ii) an initial depth of compressive layer (iDOL) into the glass sheet, and (iii) an initial central tension (iCT) within the glass sheet; and
annealing the glass sheet, after the ion exchange process has been completed, by elevating the glass sheet to one or more second temperatures for a second period of time such that at least one of the initial compressive stress (iCS), the initial depth of compressive layer (iDOL), and the initial central tension (iCT) are modified.

2. The method of claim 1, wherein during the ion exchange process, at least one of: (i) the molten salt bath includes KNO₃, (ii) the one or more first temperatures are within the range of about 370-500° C., and (iii) the first time period is within the range of about 4-24 hours.

3. The method of claim 1, wherein during the annealing process, at least one of: (i) the anneal process is carried out in an air environment; (ii) the one or more second temperatures are within the range of about 400-550° C., and (iii) the second time period is within the range of about 0.5-24 hours.

4. The method of claim 1, wherein after the ion exchange process, the initial compressive stress (iCS) exceeds a predetermined value, and after the annealing process the initial compressive stress (iCS) is reduced to a final compressive stress (fCS) which is at or below the predetermined value.

5. The method of claim 1, wherein after the ion exchange process, the initial depth of compressive layer (iDOL) is below a predetermined value, and after the annealing process the initial depth of compressive layer (iDOL) is increased to a final depth of compressive layer (fDOL) which is at or above the predetermined value.

6. The method of claim 1, wherein after the ion exchange process, the initial central tension (iCT) exceeds a predetermined value, and after the annealing process the initial central tension (iCT) is reduced to a final central tension (fCT) which is at or below the predetermined value.

7. The method of claim 1, wherein the initial compressive stress (iCS) is at or greater than about 500 MPa, and the final compressive stress (fCS) is at or less than about 350 MPa.

8. The method of claim 1, wherein the initial depth of compressive layer (IDOL) at or less than about 75 μm, and the final depth of compressive layer (fDOL) is at or above about 80 μm.

9. The method of claim 1, wherein the initial central tension (iCT) is at or above a frangibility limit of the glass sheet, and the final central tension (fCT) is below the frangibility limit of the glass sheet.

10. An apparatus, comprising a glass sheet having: (i) a compressive stress (CS) at a surface of the glass sheet, having been subject to ion exchange, that is at or less than about 350 MPa, (ii) a depth of compressive layer (DOL) into the glass sheet that is at or above about 80 μm, and (iii) a central tension (CT) within the glass sheet that is below a frangibility limit of the glass sheet.
